(19) United States
(12) Patent Application Publication
(10) Pub. No.: US 2007/0184296 A1
(43) Pub. Date: Aug. 9, 2007

(54) Process for treating elements made from non-dried wood

(75) Inventors: Andre Besner, Montreal (CA); Jean-Francois Labrecque, Montreal (CA)

Correspondence Address: BUCHANAN, INGERSOLL & ROONEY PC, POST OFFICE BOX 1404, ALEXANDRIA, VA, 22313-1404, US

(73) Assignee: HYDRO-QUEBEC, Montreal (CA)

(21) Appl. No.: 10/566,676

(22) PCT Filed: Aug. 2, 2004
(86) PCT No.: PCT/CA04/01442

§ 371 Date: Dec. 20, 2006

Related U.S. Application Data
(60) Provisional application No. 60/491,526, filed on Aug. 1, 2003.

(51) Int. Cl. B05D 3/02; B27K 3/15

(52) U.S. Cl. 428/541; 427/297; 427/317; 427/383.1; 427/393; 427/440

(57) ABSTRACT

A process for the treatment of wooden elements, said process comprising the following steps: conditioning said wooden elements to reduce their moisture content; and a) performing one of the following sequences of steps selected from the group consisting of at least the sequence of steps b1) to b4) or at least the sequence of steps bb1) to bb2); said sequence of step b1) to b4) at least comprising: b1) impregnating the wooden elements obtained from step a) with at least one wood preservative, b2) heating the wooden elements obtained from step b1) at a temperature of at least 51 & deg; C. to fix said wood preservative(s) in said wooden elements, b3) impregnating the wooden elements obtained from step b2) with a solution comprising polymerizable reactive groups, identical or different, that can form a polymer under polymerizing condition, and b4) subjecting the wooden elements obtained from step b3) to polymerizing condition to polymerize said reactive group(s); said sequence of steps bb1) to bb2) at least comprising: bb1) impregnating the wooden elements obtained from step a) with a mixture of at least one wood preservative and polymerizable reactive groups, identical or different, that can form a polymer under polymerizing condition, and bb1) heating the wooden elements obtained from step bb2) at a temperature of at least 51 & deg; C. to fix the wood preservative(s) and to polymerize said reactive groups. The treated wooden elements so obtained and their uses.

### FIELD OF THE INVENTION

The invention relates to a process for the treatment of wooden elements. These elements are advantageously made from non-dried wood in order inter alia to permanently decrease their hardness. Preferably, said non-dried wooden elements may consist of poles or analogous articles made from green wood.

Another object of the present invention relates to the treated wooden elements obtained as a result of any process according to the present invention. A further object of the present invention relates to the use of said treated wooden elements in a distribution network of electricity or telecommunication, especially as outdoor supporting elements for transformers, wires, etc.

### DESCRIPTION OF PRIOR ART

U.S. patent application Ser. No. 10/258,612 describes a wood treatment, in the presence of an oxidizing agent, resulting in a permanent reduction of the hardness of the wood.

However, none of the prior art processes for treating wood engages limited quantities of chemical auxiliary products and allow to produce treated wooden elements exhibiting inter alia a hardness that is permanently reduced.

### SUMMARY OF THE INVENTION

Advantageously, the present invention relates to a process for the treatment of wooden elements, said process comprising the following steps:
a) conditioning said wooden elements to reduce their moisture content; and
b) performing one of the following sequences of steps selected from the group consisting of at least the sequence of steps b1) to b4) or at least the sequence of steps bb1) to bb2);
   said sequence of steps b1) to b4) at least comprising:
      b1) impregnating the wooden elements obtained from step a) with at least one wood preservative,
      b2) heating the wooden elements obtained from step b1) at a temperature of at least 51° C. to fix said wood preservative(s) in said wooden elements,
      b3) impregnating the wooden elements obtained from step b2) with a solution comprising polymerizable reactive groups, identical or different, that can form a polymer under polymerizing condition, and
      b4) subjecting the wooden elements obtained from step b3) to polymerizing condition to polymerize said reactive group(s);
   said sequence of steps bb1) to bb2) at least comprising:
      bb1) impregnating the wooden elements obtained from step a) with a mixture of at least one wood preservative and polymerizable reactive groups, identical or different, that can form a polymer under polymerizing condition, and
      bb2) heating the wooden elements obtained from step bb1) at a temperature of at least 51° C. to fix the wood preservative(s) and to polymerize said reactive groups.

According to a preferred aspect, the invention relates to a process characterized in that it comprises the following steps:
a) conditioning said wooden elements to reduce their moisture content; and
b1) impregnating the wooden elements obtained from step a) with at least one wood preservative,
b2) heating the wooden elements obtained from step b1) at a temperature of at least 51° C. to fix said wood preservative(s) in said wooden elements;
b3) impregnating the wooden elements obtained from step b2) with a mixture comprising wood preservative and polymerizable reactive groups, identical or different, that can form a polymer under polymerizing condition, and
b4) subjecting the wooden elements obtained from step b3) to polymerizing condition to polymerize said reactive group(s).

Preferably, a further step may be comprised between steps b2) and b3). This further step is a cooling step of the wooden elements obtained from step b2). Advantageously, said cooling step may be carried out until said wooden elements reach a temperature of 30° C. or less in the outer 25 num of said wood elements. Preferably, the cooling step may be carried out for at least 1 to 12 hours.

According to another preferred aspect, the invention relates to a process characterized in that it comprises the following steps:
a) conditioning said wooden elements to reduce their moisture content;
bb1) impregnating the wooden elements obtained from step a) with a mixture comprising at least one wood preservative and polymerizable reactive groups, identical or different, that can form a polymer under polymerizing condition, and
bb2) heating the wooden elements obtained from step bb1) at a temperature of at least 51° C. to fix the wood preservative(s) and to polymerize said reactive groups.

Preferably, before step a), wooden elements may have a moisture content above the fiber saturation point, advantageously a moisture content higher than 30% and preferably a moisture content comprised between 50 and 130%. Wooden elements may consist of green wood elements.

Advantageously, a further step may be provided after step b4) or bb2). Preferably, said further step is a drying step of the wooden elements obtained from step b4) or bb2). More preferably, said drying step may be of the type selected from the group consisting of kiln drying, air drying and air seasoning. This optional step is advantageously provided only when it is required to adjust the moisture content of wooden elements to meet with specific requirements of some applications or clients.

Advantageously, the wood preservative is a water-borne wood preservative. Preferably, said wood preservative may be a water-borne wood preservative selected from the group consisting of Ammoniacal Copper Quat. (ACQ), copper azole, Ammoniacal Copper Arsenate (ACA) and Chromated Copper Arsenate (CCA).

Advantageously, the polymerizable reactive groups are of the type having a reactive double bond or issued from a compound having a reactive double bond. More preferably, said reactive groups may be selected from the group consisting of allyl group, vinyl group, acrylate group, methacrylate group and polymers comprising at least one group selected from the group consisting of allyl group, vinyl group, acrylate group and methacrylate group. According to a particularly preferred aspect of the invention, said reactive groups are polyethylene glycol diacrylate or polyethylene glycol dimethacrylate, especially polyethylene glycol diacrylate or polyethylene glycol dimethacrylate, having a molecular weight comprised between 600 and 10000 daltons.

Advantageously, the impregnation step b1) may be carried out with any aqueous solution of wood preservative known in the art, preferably with a solution containing up to 2.5% in weight of said wood preservative. According to a particularly preferred aspect of the invention, a 2.0-2.5% CCA-C solution may be used.

Advantageously, the impregnation step b3) may be carried out with an aqueous solution of polymerizable reactive groups having a reactive double bond or issued from a compound having a reactive double bond, preferably a solution containing from 2 to 12% in weight of said reactive groups, preferably from 5 to 12% in weight of said reactive groups. More preferably, said solution may further comprise small amounts of wood preservative used in step b2), more preferably from 0.04 to 0.12% of said wood preservative such as for example CCA-C.

Advantageously, the impregnation step bb1 ) may be carried out with a solution comprising from 2 to 5% of polymerizable reactive groups having a reactive double bond or issued from a compound having a reactive double bond, and preferably 2.0% or more of wood preservative (preferably CCA-C).

Advantageously, the moisture content of the wooden elements obtained from step a) is comprised between 15 to 35%, preferably from 24 to 26% and especially about 25%. Preferably, the drying step a) may be of the type selected from the group consisting of kiln drying, air drying and air seasoning.

Advantageously, the amount of wood preservative impregnated in the wooden elements may be superior or equal to 9.6 kg/m³, according to a standardized assay zone for analytical purposes as defined in CSA-O80 and AWPA C-4 standards.

Advantageously, the amount of polymerisable solution impregnated in the outer 13 mm of the wooden elements may be comprised between 10 and 40 kg/m³ of wooden elements.

According to another object, the invention relates to treated wooden elements whenever obtained according to the process of the present invention defined herein above. Advantageously, said treated wooden elements have their resistance to gaff penetration lower than that treated with wood preservative only.

According to another object, the invention relates to the use of treated wooden elements as defined hereinbefore, said use being characterized in that they are part of a distribution network for electrical or telecommunications purposes.

### DESCRIPTION OF PREFERRED EMBODIMENTS OF THE INVENTION.

The following preferred embodiment of the invention are given as a matter of exemplification only and should not be regarded as representing any limitation of the invention for which protection is claimed.

It has been surprisingly found that excellent results may be obtained by treating wood elements without addition of an oxidizing agent.

Treatment with a CCA Based Wood Preservative Solution

Steps involved for the treatment of wooden poles according to the invention preferably at least comprises following steps a), b), c), e) and f) and more preferably further comprises following steps d) and/or g). Said steps a) to g) are the following:
a) Conditioning for example drying (such as in a kiln, by air drying or by air seasoning) wooden elements, (preferably of green wood elements advantageously having a moisture content above the fiber saturation point, advantageously a moisture content higher than 30% and more particularly comprised between 50 and 130%), to a moisture content comprised between 15 and 35%, more preferably to a moisture content comprised between 24 to 26% more particularly about 25%;
b) CCA treatment;
c) CCA fixation;
d) cooling period (optional);
e) polymer impregnation (for example with DM-PEG);
f) polymerization such as a polymerization by cross-linking (for example DM-PEG polymerization); and
g) final drying (optional).

Raw material: trees, preferably Red Pine and Jack Pine poles may be treated with the DM-PEG polymer additive. The treating cycles will vary some by species as well as the treatability, amount of sapwood and moisture content of the poles. Note that some specifications may require kiln drying to a specified moisture content after the final polymerization.

According to a preferred embodiment,-the poles to be treated have been obtained from trees by debarking.

a) Initial Driving

Wood poles shall be preferably either kiln (between 5 and 25 days) or air dried (between 3 and 12 months) adequately to permit penetration of the wood preservative in compliance with the specifications. In general, this means that the moisture content at the end of the initial drying step should be around 25% in the inner portion of the sapwood.

b) Wood Preservative Treatment (Chromated Copper Arsenate: CCA)

According to a preferred embodiment, the current practice is to treat the pole first with a wood preservative (CCA) using a cycle that is modified (reduced initial vacuum, full final vacuum) enough to obtain a wood preservative kickback during final vacuum at least as great as the required pickup of DM-PEG. This ensures adequate space in the pole for injection of the DM-PEG. In this regard, any autoclave of the type well-known to skilled workmen for the impregnation of wood preservative may be used.

The poles are advantageously treated using a 2.0-2.5% CCA-C solution to meet the requirements of the CSA-O80.4 and/or AWPA C4 standards:

| | Red Pine | Jack Pine |
|---|---|---|
| Penetration | 75 mm (3″) or 90% of the | 25 mm (1.0″) or 90% of the |
| | sapwood | sapwood |
| Assay Zone | 2-41 mm (0.1″-1.6″) | 2-19 mm (0.1″-0.75″) |
| Assay | 9.6 kg/m³ (0.60 pcf) | 9.6 kg/m³ (0.60 pcf) |
| Retention | | |

CCA Treating Targets Were:

| | Red Pine | Jack Pine |
|---|---|---|
| Gross Solution | 416 L/m³ (2.6 imp gal per | 256 L/m³ (1.6 imp gal per |
| | cubic foot) | cubic foot) |
| Net Solution | 256 L/m³ (1.6 imp gal per | 160 L/m³ (1.0 imp gal per |
| | cubic foot) | cubic foot) |
| Kickback | 160 L/m³ (1.0 imp gal per | 96 L/m³ (0.6 imp gal per |
| | cubic foot) | cubic foot) |

Typical CCA Treating Cycle:

| | Red Pine | Jack Pine |
|---|---|---|
| Initial Vacuum | 10 min. at | 10 min. at 68 kPa |
| | 68 kPa (20″ Hg) | (20″ Hg) |
| Press | 45-60 min. at | 60-90 min. at |
| | 1050 kPa (150 psi) | 1050 kPa (150 psi) |
| Final Vacuum | 60 min. at | 80-90 min. at |
| | 81+ kPa (24+″ Hg) | 81+ kPa (24+″ Hg) |

The length of pressure is adjusted to get the desired gross solution injection to ensure penetration in conformance with requirements. The initial and final vacuum must be such that they result in a minimum kickback of 160 L of solution per cubic meter (1.0 Imperial gallon of solution per cubic foot) on red pine and 96 L of solution per cubic meter (0.6 Imperial gallon of solution per cubic foot) on jack pine. This will make certain that there is adequate room in the wood for injection of the DM-PEG solution. To increase the kickback, the amount of initial vacuum may be reduced and/or the length of the final vacuum may be increased.

c) CCA Fixation

A fixation period between CCA and DM-PEG treatment takes advantageously place. Prior to fixation treated poles are preferably stored in a manner to minimize drying in order to avoid inhibition of the fixation phenomena as the CCA fixation proceeds in a liquid media.

Fixation of CCA in the outer 13 mm (one-half inch) of the poles shall be preferably accomplished by heating the poles in a saturated atmosphere in the kiln (wet bulb set same as dry bulb and no venting) at a minimum temperature of 51° C. (150° F.). When it is believed that fixation is complete, borings shall be taken and the outer 13 mm (one-half inch) zone shall be checked using the chromotropic acid test for fixation. If not completely fixed, the cycle shall be advantageously extended to provide complete fixation. The length of time required to achieve fixation is dependent on the treating plant equipment and practice, so each plant will need to determine the length of time required in their facility.

The results of testing for fixation of each charge is documented and kept as part of the charge record.

d) Cooling Period

A cooling period takes advantageously place between the fixation and treatment with DM-PEG. The wood is preferably cooled until it is not more than 30° C. (86° F.) in the outer 25 mm (one inch). This can generally be accomplished by allowing the poles to sit at ambient conditions for a minimum of 12 hours after completion of the fixation process and removal from the fixation chamber.

It has been surprisingly found that the cooling period results in preventing premature polymerization of the DM-PEG solution during the treating cycle. If it polymerizes too quickly, it will be difficult to obtain a complete penetration of the outer 25 mm (1″) shell.

DM-PEG Treatment

The poles are advantageously treated by using a 5-12% DMPEG impregnation solution containing between 0.04 and 0.12% of CCA-C as a polymerization inhibitor for a two impregnation steps treatment or a 2-5% DMPEG solution containing 2.0% CCA-C or more as a polymerization inhibitor and wood preservative for a one impregnation step treatment.

The plant may advantageously establish gauge retention criteria to achieve an assay retention of 19 kg/m³ (1.2 pcf DM-PEG in the outer 13 mm (½ inch) of the pole. The following target solution and gauge retentions may for example be used for initial treatments to establish the plant requirements and shall be confirmed and/or adjusted as required to meet the assay retention:

| | Red Pine | Jack Pine |
|---|---|---|
| Gauge | 6.4 kg/m³ (0.40 pcf) (min.) | 6.4 kg/m³ (0.40 pcf) (min.) |
| Retention | | |

DM-PEG Target Treating Injections Are:

| | Red Pine | Jack Pine |
|---|---|---|
| Gross | 176 L/m³ (1.0-1.2 imp gal per | 128 L/m³ (0.7-0.9 imp gal per |
| Solution | cubic foot) | cubic foot) |
| Net | 80 L/m³ (0.4-0.6 imp gal per | 80 L/m³ (0.4-0.6 imp gal per |
| Solution | cubic foot) | cubic foot) |

Typical DM-PEG Treating Cycle:

| | Red Pine | Jack Pine |
|---|---|---|
| Concentration | 8% (min.) | 8% (min.) |
| Initial Vacuum | 10 min. at 81 kPa | 10 min. at 81 kPa |
| | (24″ Hg) | (24″ Hg) |
| Press | 15-20 min. at | 15-20 min. at |
| | 1050 kPa (150 psi) | 1050 kPa (150 psi) |
| Final Vacuum | 25-30 min. at | 15-30 min. at |
| | 81 kPa (24″ Hg) | 68 kPa (20″ Hg) |

On charges with gross solution injections less than the maximums listed reduce the final vacuum to reduce risk of removing too much DM-PEG from the outer shell of the poles. Plants equipped to strip solution from the cylinder during final vacuum preferably monitor the kickback and terminate the vacuum when the net retention has been reduced to 6.4-7.2 kg/m³ (0.40-0.45 pcf).

When the gauge retentions are less than the targets, the net solution retentions may be raised by injecting more solution or reducing the final vacuum. The solution concentration may be raised to increase the gauge retention without changing the cycle.

These suggested cycles are starting points and may be modified as required to ensure that poles meet the requirements for CCA and DM-PEG retention and penetration without unnecessary over treatment. When poles are treated with CCA and allowed to partially season prior to treatment with DM-PEG, care will need to be taken to prevent excess injection of DM-PEG solution. Shorter press periods and lower pressure can be used to limit injection. Care should also be used to avoid excessive final vacuum that can strip too much DM-PEG from the outer shell during attempts to lower total retention caused by excess penetration.

f) DM-PEG Polymerization

Treated poles are advantageously conditioned after treatment to polymerize (chemically cross-link) the DM-PEG. The polymerization is a temperature-dependent process, which requires approximately 24 to 48 hours at 55-70° C. (150-160° F.). The atmosphere in the polymerization chamber must be kept saturated so that the wood will not dry out prior to completion of polymerization.

Polymerization of poles is preferably monitored during startup to establish a schedule for each plant that provides for adequate polymerization after treatment. Differences in equipment at plants may result in considerably different schedules to accomplish equivalent polymerization.

In the meaning of the present invention:

CCA-C means Chromated Copper Arsenate of type C, the C type corresponds to the following proportions:

| | min. (%) | max. (%) |
|---|---|---|
| hexavalent chromium, as CrO₃ | 44.5 | 50.5 |
| Copper oxide, as CuO | 17.0 | 21.0 |
| Arsenic, as As₂O₅ | 30.0 | 38.0 |

chromate 47.5% (this rate may vary, + or −3%); cupper oxide 18.5% (this rate may vary, + or −1.5%); and arsenate 34% (this rate may vary + or −4%),

in the case of the reported examples the following proportions were used hexavalent chromium 48%, cupper oxide 19% and arsenic 33%;
DM-PEG means dimethacrylate polyethylene glycol;
CSA means Canadian Standards Association;
AWPA means American Wood-Preservers' Association;
pcf means pound per cubic foot (concentration in the wood, mass per volumic unit, the equivalent metric unit being kilogram per cubic meter);
imp. gal. means imperial gallon;
min. means minute;
psi: means pound per square inch;
20″ means a pressure of 20 inches Hg (corresponds to the vacuum); and
24+ means pressures higher or equal to 24 inches Hg.

The absence of a thermo-initiator in the process results in a reduction of the instability of the cross-linkable polymer solution, this simultaneously results in an ability to reduce the concentration of CCA (used as a polymerization inhibitor) from 0.5%, to a range from 0.04 to 0.12% in a two impregnation steps treatment. The elimination of sodium persulfate (used as a thermo-initiator) reduces the corrosivity (ability to generate corrosion) and conductivity of the final product, since there is no more sulfate ions originating from said thermo-initiator. For some specific application, the conductivity as well as the corrosivity may reduce the useful lifetime of equipments attached to the treated wood elements, represent important features of the process. Such phenomena of conductivity and corrosivity were observed in the prior art process, especially processes using potassium persulfate. However, these drawbacks are avoided or minimized with a process according to the invention.

Finally, the elimination of the thermo-initiator reduces the kinetic of the polymerization reaction, allowing a favorable phenomena to take place, ita est the diffusion of DM-PEG molecules to the surface of the poles during drying of the wooden elements and to simultaneously result in an increase of the DMPEG content, where requested.

Although particular embodiments have been described, this was for the purpose of illustrating, but not limiting the invention. Various modifications, which will come readily to the mind of one skilled in the art, are within the scope of the invention as defined in the appended claims.

### EXAMPLE 1

### Two-Impregnation Steps Treatment

Twenty-two (22) air-dried 40-foot class 4 Red pine poles have been selected to be pressure-treated in a commercially operated cylinder using a two impregnation steps treatment. These poles have an average moisture content of 25.0%. The first step consisted in impregnating the poles using a 2.21% CCA-C wood preservative solution under the following conditions:

| | |
|---|---|
| Initial vacuum: | 24″ Hg, 15 min |
| Pressurization: | 150 psi, 55 min |
| Final vacuum: | 18″ Hg, 30 min |

The second step consisted in impregnating the poles using a cross-linkable solution made of: 0.1% CCA, acting as both corrosion/polymerization inhibitor (to prevent DMPEG polymerization in the work tank, treating cylinder, etc. at ambient temperature), 10% DMPEG 1000 under the following conditions:

| | |
|---|---|
| Initial vacuum: | 24″ Hg, 18 min |
| Pressurization: | 150 psi, 25 min |
| Final vacuum: | 24″ Hg, 25 min |

After the treatment, the stub was conditioned in a dry kiln at a temperature of 60° C. for 48 hours. The concentration of DMPEG 1000 is established in 2 radial zones (zones 0-0.50 and 0.50-1.0 inch) from a total of 10 wood cores sampled from ten poles and pooled. Samplings were done periodically to follow the progression of the polymerization and at the end of the final drying of the pole.

The polymerization results are given in the following table:

| Duration of | Residual uncross-linked DMPEG 1000 conc. in pcf | |
|---|---|---|
| heating at | (polymerization in %) | |
| 60° C. after | Radial zone | |
| treatment | 0-0.50 inch | 0.50-1.0 inch |
| 0 h | 1.37 (0%) | 1.10 (0%) |
| 12 h | 0.45 (66.7%) | 0.17 (84.8%) |
| 20 h | 0.49 (64.5%) | 0.21 (80.7) |
| 30 h | 0.84 (38.8%) | 0.31 (71.9%) |
| 48 h | 0.31 (77.2%) | 0.16 (85.3%) |

These results show two of the findings claimed. The first being that an appreciable amount of the cross-linkable polymer is able to polymerize in the wood matrix in absence of any thermo-initiator. The polymerization reaches 77.2% in the first half-inch and 85.3% in the second half inch from the surface. The second being that when closely examining the residual concentrations of DMPEG in these two radial zones, one is able to derive that there is a movement of the PEG-DM from the inner zones to the surface of the pole, as the residual concentration increased from 0.45 pcf after 12 hours of heating (during which the polymerization proceeds) to 0.49 pcf after 20 hours, then 0.84 pcf, after which it decreases as a result of the diminishing movement towards the surface combined to the continuation of the polymerization;

### EXAMPLE 2

### One Impregnation-Step Treatment

One air-dried 24 inches long (with a diameter of 8 inches) Red pine pole stub has been pressure-treated in a laboratory-scale cylinder using a one impregnation step treatment. The stub presented an average moisture content of 20.0%. The one impregnation step consisted in impregnating the poles using a solution containing both 2.6% CCA-C and 3% DM-PEG 1000 under the following conditions:

| | |
|---|---|
| Initial vacuum: | 24″ Hg, 15 min |
| Pressurization: | 150 psi, 90 min |
| Final vacuum: | 24″ Hg, 60 min |

After the treatment, the stub was conditioned in a dry kiln at a temperature of 60° C. for 48 hours. The concentration of DMPEG 1000 is established in 6 radial zones (zones 0-0.25, 0.25-0.50, 0.50-0.75, 0.75-1.0, 1.0-1.5, 1.5-2.5 inch) from 4 wood cores sampled 90° apart at the mid-length of the section and pooled. Samplings were done periodically to follow the progression of the polymerization and at the end of the final drying of the pole.

The polymerization results are given in the following table:

| | Residual uncross-linked DM-PEG 1000 conc. in pcf | | | | | |
|---|---|---|---|---|---|---|
| Duration of heating | (Polymerization in %) | | | | | |
| at 60° C. after | Radial Zone | | | | | |
| treatment | 0-0.25″ | 0.25-0.50″ | 0.50-0.75″ | 0.75-1.0″ | 1.0-1.5″ | 1.5-2.5″ |
| Initial | 0.99 (0%) | 1.06 (0%) | 0.67 (0%) | 0.23 (0%) | 0.074 (0%) | 0.028 (0%) |
| 2 h | 1.06 (−7.2) | 0.83 (21.5%) | 0.64 (5.3%) | 0.24 (−7.0%) | 0.04 (40.8%) | 0.01 (62.2%) |
| 4 h | 1.13 (14.4%) | 0.89 (16.2%) | 0.74 (−10.2%) | 0.35 (−53.8%) | 0.02 (74.2%) | 0.01 (46.7%) |
| 6 h | 0.78 (21.0%) | 0.80 (24.9%) | 0.42 (37.5%) | 0.18 (22.0%) | 0.01 (91.7%) | 0.00 (100%) |
| 20 h | 1.23 (−24%) | 0.50 (52.7%) | 0.52 (23.5%) | 0.19 (17.2%) | 0.08 (−10%) | 0.00 (100%) |
| 24 h | 1.12 (−12%) | 0.49 (54.2%) | 0.54 (19.3%) | 0.20 (13.4%) | 0.05 (29.2%) | 0.00 (100%) |
| 48 hours | 1.23 (−24%) | 0.30 (71.4%) | 0.21 (69.4%) | 0.12 (46.8%) | 0.034 (54.2%) | 0.000 (100%) |

| | |
|---|---|
| 48 hours | 0.58 (38.9%) |
| One month later | 0.17 (80.9%) |

These results show two of the findings claimed. The first being that an appreciable amount of the cross-linkable polymer is able to polymerize in the wood matrix in absence of any thermo-initiator. The polymerization reaches 38.9% in the 0-0.75 inch zone at the end of the drying schedule, but then continues to proceed at ambient temperature to reach 80.9% one month later. For the one-step treatment, as was observed for the two-step treatment, movement of the DM-PEG 1000 is also observed, as concentration of DM-PEG at the surface went from 0.99 pcf after the treatment up to 1.23 pcf after 48 hours of heating.

### Effect of Sodium Persulfate on the Corrosivity of a DMPEG 1000 Solution

Summary

Corrosion rates were determined for DMPEG solutions with and without sodium persulfate and compared to tap water. Without persulfate, corrosion rates were similar to that of tap water. Addition of persulfate approximately doubled the rate of corrosion.

Introduction

Corrosion tests were conducted on simulated DMPEG working tank solutions to determine the rate of corrosion with and without the addition of the persulfate thermo-initiator. The testing procedure was based on AWPA standard method E17-99 C1010 using mild steel coupons. Corrosion rates were calculated from the average weight loss of the coupons exposed to each solution.

Experimental

Six metal coupons were used for each test solution. These were 3×½×″× 1/16″ in dimension with a hole near one end, and were made out of C1010 mild steel. They were cleaned prior to testing in accordance with AWPA standard method E17-99, and randomly weighed three times to the nearest milligram using an analytical scale.

The coupons were suspended in two different positions in the beakers: three were laid on the bottom, to be completely submerged by the treatment solution and three were suspended with wire from the top of the beaker at a height that would let them hang half-way into the solution. The wires were secured to the top of the beaker with rubber bands.

Two solutions containing 10% DMPEG 1000 were prepared using tap water. To one of these solutions, 0.5% sodium persulfate was added before final dilution. Approxiniately 250 mL of each solution was poured into each beaker. A tap water control was also tested for comparison. The solutions were covered with paraffin and stored at ambient temperature.

After 24 hours, the solution with sodium persulfate had polymerized and rust was evident on the coupons; the solution without sodium persulfate did not polymerize. However, the test was continued for the remainder of the three-week test period. The solutions were then collected and stored in Nalgene bottles; the coupons were removed from the wires and cleaned and dried according to the E17-99 procedure. Each coupon was then randomly weighed three times using the analytical scale, and the corrosion rates for each concentrate were calculated in mils/year.

Results

The corrosion rates obtained for the DMPEG solutions are given in the table below. For solutions of DMPEG without persulfate, the corrosion rates were similar to that of tap water. The rates about doubled when the persulfate was added.

| | Coupon | Corrosion rate | Average corrosion |
|---|---|---|---|
| Solution | position | (mpy) | rate (mpy) |
| 10% (w/w) DMPEG | Submerged | 1.17 | 1.11 |
| 1000 without | | 1.01 | |
| sodium persulfate | | 1.17 | |
| | Half-way | 1.09 | 1.13 |
| | | 1.13 | |
| | | 1.15 | |
| 10% (w/w) DMPEG | Submerged | 2.11 | 2.34 |
| 1000 with 0.5% | | 2.41 | |
| sodium persulfate | | 2.51 | |
| | Half-way | 4.27 | 3.83 |
| | | 3.68 | |
| | | 3.53 | |
| Tap water | Submerged | 1.39 | 1.46 |
| | | 1.47 | |
| | | 1.53 | |
| | Half-way | 1.84 | 1.68 |
| | | 1.50 | |
| | | 1.69 | |

### Climbability of Red Pine Dole Sections Treated Using a One-Step Impregnating Process with a Solution Containing 2.6% CCA, 3% DMPEG 1000 and No Thermo-Initiator

Red Pine pole sections were impregnated by a treating solution of the following composition: 2.6% CCA, 3% DMPEG 1000 and no thermo-initiator using a one-step process. These pole sections were poked using an instrumentation developed at Hydro-Quebec Research Institute and the results were compared with those obtained from pentachlorophenol-treated pole sections identified as PCP #1 to PCP #3. The instrumentation developed determines the climbability of a pole, as expressed by linemen, by measuring two parameters: the impact of the gaff with the wood and its penetration. These parameters are combined to produce the climbability index (IC). The wood hardness increase with the increasing value of IC. The impact is the deceleration of the gaff as it touches the wood. For example, a gaff poked into a hard pole will produce a higher impact than the same gaff penetrating a softer pole. This parameter is being used by Hydro-Québec's linemen to evaluate their perception of climbability of a pole when the wood is hard. The penetration measured is that of a Bashlin gaff projected on the surface of the pole with an acceleration equivalent to those typically generated by Hydro-Québec's linemen when climbing a pole. For very soft poles, the impacts are low and do not allow to discriminate easily between two similar poles. In this situation, the gaff penetration becomes the prime parameter by which to judge soft poles.

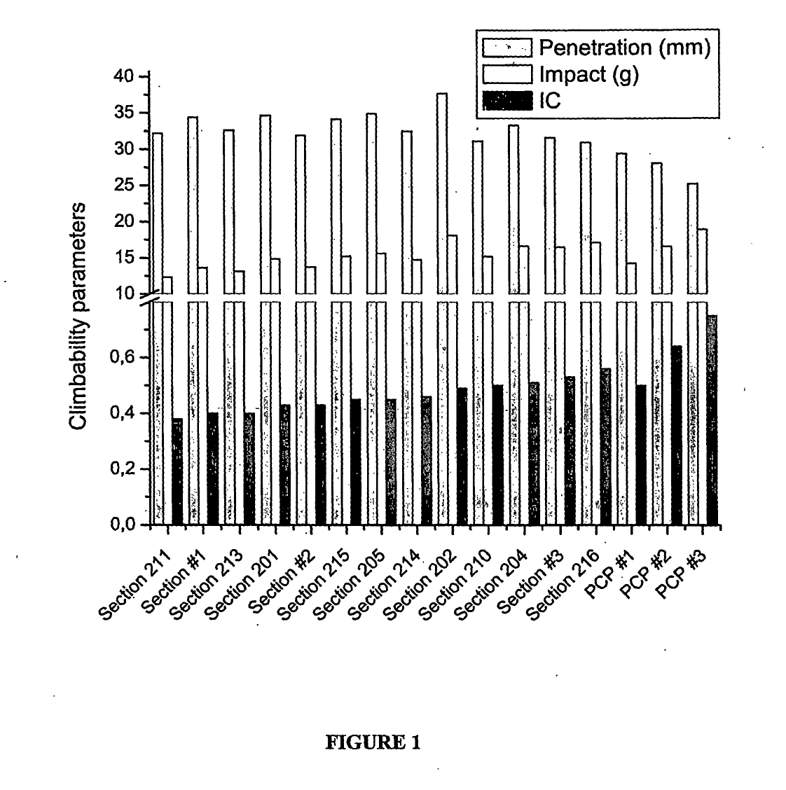

As climbability is affected by the moisture content (MC) of wood, all the stubs were conditioned several weeks in an environmental walk-in set at 18° C. and 95% RH. The MC was determined in several stubs and ranged between 19 and 20%. The climbabihty measurements taken are presented in the following FIG. 1. For each stub, a minimum of four pokings was done at three locations, 120° apart, at mid-length. For presentation purposes, only the average is reported here. The climbability index values range from 0.38 (very soft) to 0.56 (soft) for those stubs treated with CCA and DMPEG 1000. The climbability index values of the PCP-treated pole sections (considered to be a wood softness reference, as this is an oilborne preservative) are 0.50, 0.64 and 0.75. The 13 pole sections treated with CCA and DMPEG 1000 are all softer than two of the three PCP pole sections. In fact, nine of these pole sections are even softer than the three PCP-treated pole sections, therefore showing the effect of the DMPEG 1000 on the overall softness of the wood.

The invention is not restricted to the above-mentioned preferred statements and also relates to all variations that may appear obvious to a skilled workman.

1-24. (canceled)

25. Process for the treatment of wooden elements, said process comprising the following steps:
a) conditioning said wooden elements to reduce their moisture content; and
b) performing one of the following sequences of steps selected from the group consisting of at least the sequence of steps b1) to b4) or at least the sequence of steps bb1) to bb2);
said sequence of steps b1) to b4) at least comprising:
b1) impregnating the wooden elements obtained from step a) with at least one water-borne wood preservative,
b2) heating the wooden elements obtained from step b1) at a temperature of at least 51° C., to fix said wood preservative(s) in said wooden elements;
b3) impregnating the wooden elements obtained from step b2) with a solution comprising polymerizable reactive groups having a reactive double bond, identical or different, that will form a polymer under polymerizing condition, and
b4) subjecting the wooden elements obtained from step b3) to polymerizing condition to polymerize said reactive group(s);
said sequence of steps bb1) to bb2) at least comprising:
bb3) impregnating the wooden elements obtained from step a) with a mixture comprising at least one water-borne wood preservative and polymerizable reactive groups having a reactive double bond, identical or different, that will form a polymer under polymerizing condition, and
bb2) heating the wooden elements obtained from step bb1) at a temperature of at least 51° C. to fix said wood preservative(s) and to polymerize said reactive groups.

26. Process according to claim 25, wherein it comprises the following steps:
a) conditioning said wooden elements to reduce their moisture content; and b1) impregnating the wooden elements obtained from step a) with at least one water-borne wood preservative,
b2) heating the wooden elements obtained from step b1) at a temperature of at least 51° C., to fix said wood preservative(s) in said wooden elements,
b3) impregnating the wooden elements obtained from step b2) with a polymerizing solution comprising reactive groups having a reactive double bond, identical or different, that will form a polymer under polymerizing condition, and at least one water-borne wood preservative, identical or different than the one of step b1)
b4) subjecting the wooden elements obtained from step b3) to polymerizing condition to polymerize said reactive group(s).

27. Process according to claim 25, wherein it comprises the following steps:
bb1) impregnating the wooden elements obtained from step a) with a mixture comprising at least one water-borne wood preservative and polymerizable reactive groups having a reactive double bond, identical or different, that will form a polymer under polymerizing condition, and
bb2) heating the wooden elements obtained from step bb1) at a temperature of at least 51° C. to fix said wood preservative(s) and to polymerize said reactive groups.

28. Process according to claim 26, wherein the impregnation step b1) is carried out with a solution containing a wood preservative in an amount up to 2.5% in weight.

29. Process according to claim 26, wherein the impregnation step b3) is carried out with a solution containing 5 to 12% in weight of polymerizable reactive groups having a reactive double bond or issued from a compound having a reactive double bond.

30. Process according to claim 29, wherein the solution of step b3) further comprises from 0.04 to 0.12% in weight of the wood preservative of step b1).

31. Process according to claim 27, wherein the impregnation step bb1) is carried out with a solution comprising from 2 to 5% in weight of polymerizable reactive groups having a reactive double bond or issued from a compound having a reactive double bond, from 2.0 to 2.6% in weight of wood preservative.

32. Process according to claim 26, wherein the cooling step is carried out for a period of at least 1 to 12 hours.

33. Process according to claim 25, wherein it further comprises after step b4) or bb2), a drying steps of the wooden elements obtained from steps b4) or bb2).

34. Process according to claim 25, wherein the wood preservative is a water-borne wood preservative.

35. Process according to claim 34, wherein the water-borne wood preservative is selected from the group consisting of Ammoniacal Copper Quat., copper azole, Ammoniacal Copper Arsenate and Chromated Copper Arsenate.

36. Process according to claim 25, wherein said reactive groups of the polymerizable solution have a reactive double bond or are issued from a compound having a reactive double bond.

37. Process according to claim 29, wherein reactive groups are selected from the group consisting of allyl group, vinyl group, acrylate group, methacrylate group and polymers comprising at least one group selected from the group consisting of allyl group, vinyl group, acrylate group and methacrylate group.

38. Process according to claim 37, wherein said reactive groups are polyethylene glycol diacrylate or polyethylene glycol dimethacrylate.

39. Process according to claim 38, wherein said reactive groups are polyethylene glycol diacrylate or polyethylene glycol dimethacrylate, having a molecular weight comprised between 600 and 10000 daltons.

40. Process according to claim 25, wherein the moisture content of the wooden element obtained from step a) is comprised between 15 and 35%.

41. Process according to claim 40, wherein the moisture content of the wooden element obtained from step a) is comprised between 24 and 26%.

42. Process according to claim 25, wherein the drying step a) is selected from the group consisting of kiln drying, air drying and air seasoning.

43. Process according to claim 25, wherein the amount of wood preservative impregnated in the wooden elements is superior or equal to 9.6 kg/m³, according to a standardized assay zone for analytical purposes as defined in CSA-O80 and AWPA C-4 standards.

44. Process according to claim 25, wherein the amount of polymerizable reactive groups impregnated in at least 13 mm outer portion of the wooden elements is comprised between 10 and 40 kg/m³ of wooden elements.

45. Treated wooden elements whenever obtained according to the process of claim 25.
